(19) United States
(12) Patent Application Publication
(10) Pub. No.: US 2007/0174148 A1
(43) Pub. Date: Jul. 26, 2007

(54) Method for resource management in a supply chain

(76) Inventors: Francesca Schuler, Des Plaines, IL (US); Thomas S. Babin, Lake Zurich, IL (US); Julius S. Gyorfi, Vernon Hills, IL (US); Swee M. Mok, Palatine, IL (US); Andreas Schaller, Wiesbaden (DE); Mansour Toloo, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/323,516

(22) Filed: Dec. 30, 2005

(51) Int. Cl. G06Q 10/00

(52) U.S. Cl. 705/28

(57) ABSTRACT

A method for resource management in a supply chain is provided. The method is used by a pallet device (106) that can be associated with a pallet (104) in the supply chain. The pallet is associated with one or more resources. Further, the supply chain includes a decentralized control system (100) that has at least one system server, a plurality of pallets, a plurality of pallet devices, and a plurality of resources. The method includes detecting (302) an event and acquiring (304) status information of at least one of the plurality of pallets in response to the event. Further, the method includes determining (306) a reporting condition of at least one of the plurality of resources, based on the status information. The method includes reporting (308) the status information to one of at least one system server and at least one of the plurality of pallet devices, based on a positive reporting condition.

### RELATED APPLICATION

This application is related to U.S. patent application Ser. No. ______, attorney docket number CML02604T, entitled “Method and System for Request Processing in a Supply Chain”, filed on the same day hereof, and assigned to the assignee hereof.

### FIELD OF THE INVENTION

The present invention relates to the field of supply chain management, and more specifically to resource management in a supply chain.

### BACKGROUND

Supply chain management is the process of planning, implementing, and controlling the operations of a supply chain. A supply chain is a process or series of processes for providing one or more resources or products to customers. For example, a supply chain can include raw material procurement or the procurement of component parts, manufacturing products, distribution of products or services, inventory management, and product sales. A supply chain can exist entirely within a single organization or can extend to a number of organizations. Effective implementation of a supply chain makes a business enterprise competitive. Business enterprises generally use computer-implemented management systems to model supply chains and generate plans to provide resources to customers.

Inventory management is an essential part of a supply chain. There are various inventory management systems through which resources are managed in a supply chain. For example, a centralized management system has a central controller to keep track of resources. The central controller communicates with the resources at frequent intervals to check the status of the resources. To detect the exact status of resources at any given instance, the central controller frequently queries the various components of the inventory management system. Examples of components of the inventory management system include processors, sensors, databases, and so forth. These components of the inventory management system do not share information and knowledge with each other, thus raising redundant alerts to the central controller.

Frequent queries from the central controller and alerts from the various components create an overhead of information at the central controller. Therefore, there is excessive data and communication with considerable redundancy in the management system. Further, the management of excessive individual data is highly time-intensive. Moreover, processing excessive data requires high-end computing devices and makes the management system uneconomical.

### BRIEF DESCRIPTION OF THE DRAWINGS

Various embodiments will hereinafter be described in conjunction with the appended drawings, provided to illustrate and not to limit the invention, wherein like designations denote like elements, and in which:

FIG. 1 shows a block diagram illustrating a decentralized control system, in accordance with some embodiments;

FIG. 2 shows a block diagram illustrating a pallet device in communication with one or more resources and a sensor, in accordance with some embodiments;

FIG. 3 shows a flow diagram illustrating a method for resource management, in accordance with some embodiments;

FIG. 4 shows a flow diagram illustrating a method for determining a resource-missing status, in accordance with some embodiments;

FIG. 5 shows a flow diagram illustrating a method for determining a utilization status of a pallet, in accordance with some embodiments;

FIG. 6 shows a flow diagram illustrating a method for determining a pallet loading status, in accordance with some embodiments; and

FIG. 7 shows a flow diagram illustrating a method for resetting a pallet device, in accordance with some embodiments.

### DETAILED DESCRIPTION OF THE DRAWINGS

Before describing in detail the method for resource management in a supply chain, it should be observed that the present invention is comprised primarily of combinations of method steps and system components related to resource management techniques. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

Various embodiments provide a method for resource management in a supply chain. The supply chain includes a decentralized control system that has at least one system server, a plurality of pallets, a plurality of pallet devices, and a plurality of resources. A pallet device can be associated with a pallet in the supply chain. Similarly, a pallet is associated with one or more resources. When an event in the supply chain is detected, status information of at least one of the plurality of pallets is acquired in response to the event. Further, the reporting condition of one or more of the plurality of resources are determined, based on the status information. Thereafter, based on the reporting condition being positive, the status information may be reported to at least one of the system servers and/or at least one of the plurality of pallet devices.

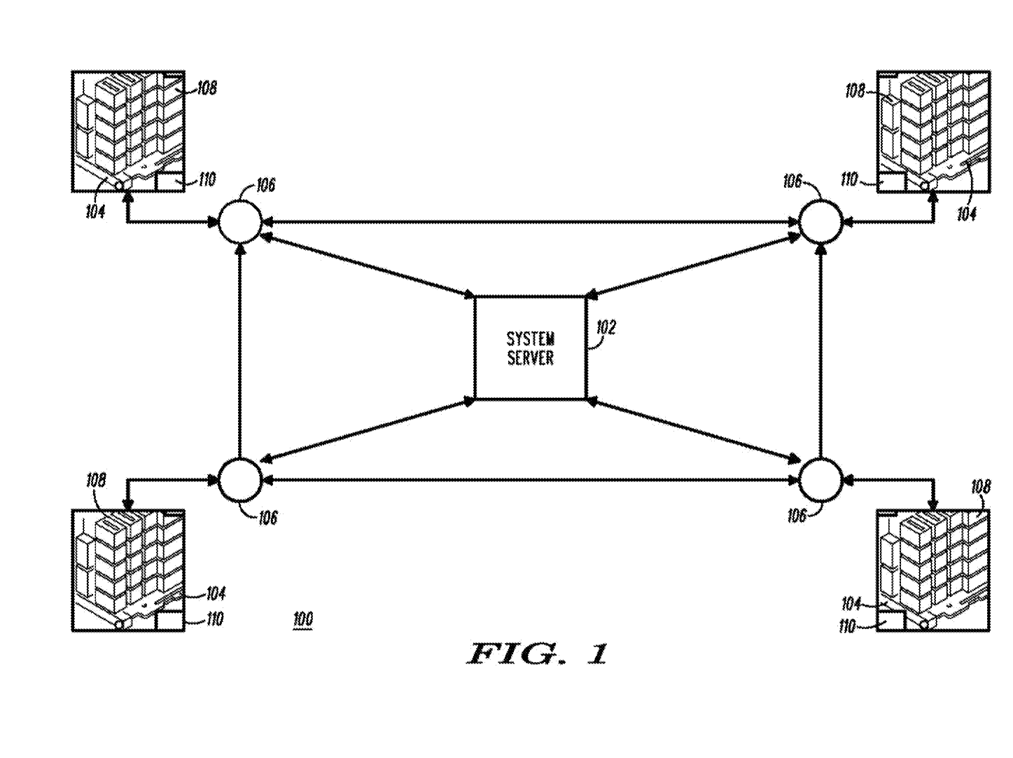

Referring to FIG. 1, a block diagram illustrates a decentralized control system 100, in accordance with some embodiments. The decentralized control system 100 includes at least one system server 102, a plurality of pallets (each identified as a pallet 104 in FIGS. 1 & 2), a plurality of pallet devices (each identified as a pallet device 106 in FIGS. 1 & 2), and a plurality of resources (each identified as a pallet 108 in FIG. 1). In accordance with some embodiments, the decentralized control system 100 also includes a plurality of sensors 110. The pallet 104 can be associated with a pallet device 106 so that the pallet device 106 can communicate with one or more resources loaded on the pallet 104. In accordance with some embodiments, each of the plurality of pallet devices and the one or more resources associated with it communicate with each other wirelessly. The plurality of pallet devices communicate with each other and with the system server 102. The system server 102 includes a central controller and one or more database servers. Each of the pallet devices 106 may include a communication unit, using which the plurality of pallet devices communicate with each other and the one or more resources. Examples of wireless communication equipment that the communication unit may include, but is not limited to, a Global Positioning System (GPS), a Wireless Local Area Network (WLAN), a Radio Frequency Identification (RFID) tag, and so forth.

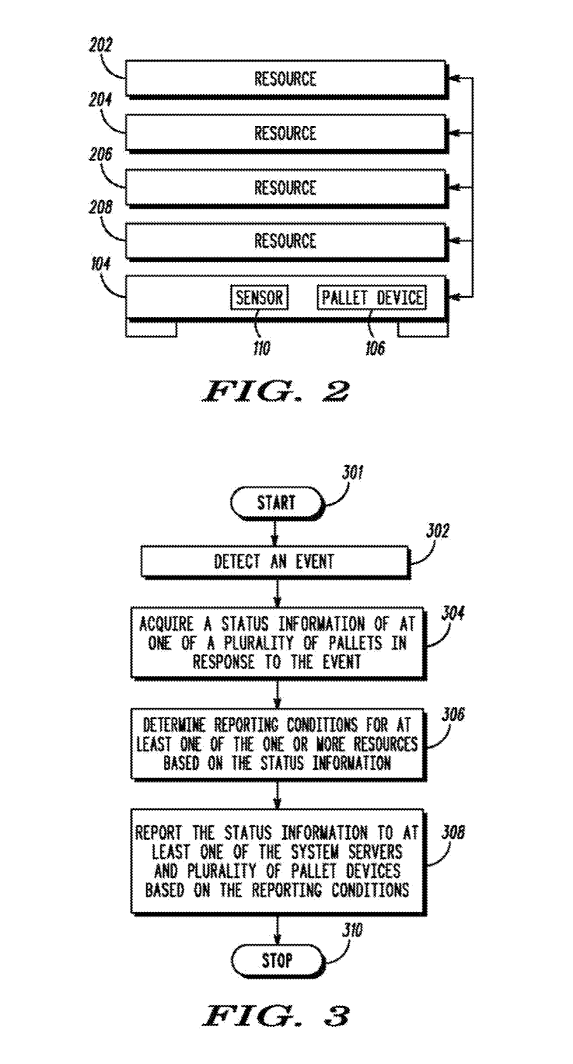

Referring to FIG. 2, a block diagram illustrates the pallet device 106 in communication with one or more resources and the sensor 110, in accordance with some embodiments. There are four resources 202, 204, 206 and 208 loaded on the pallet 104. Each of the four resources 202, 204, 206 and 208 is coupled with a radio frequency identification (RFID) tag, which communicates wirelessly with the pallet device 106. Further, the pallet device communicates with the sensor 110, which is mounted on the pallet 104. The sensor 110 senses different parameters of the resources loaded on the pallet 104. Examples of sensors include, but are not limited to, a weight sensor, a volume sensor, and a temperature sensor. In accordance with some embodiments, the pallet device 106 can be mounted on the pallet 104. The pallet device 106 interacts with the one or more database servers through the system server 102 and updates information about the resources loaded on the pallet 104 based on alerts raised by the plurality of pallet devices, or other events in the supply management system 100.

Referring to FIG. 3, a flow diagram illustrates a method for resource management, in accordance with some embodiments. At step 301, the method for resource management is initiated. At step 302, an event in the supply chain is detected. An event can be a change in a sensed value, a time-related condition, or receipt of a wireless message, or a sensed value meeting a criterion. Examples of a sensed value include but are not limited to weight, physical location, temperature, pressure and chemical presence. Examples of a time-related condition include, but are not limited to, a periodic condition, a duration of time elapsed since the occurrence of some other event, and a real time value such as 3:35 PM. Examples of receipt of a wireless message include, but are not limited to, a message from another pallet device and a message from a server.

At step 304, the status information of at least one of the plurality of pallets is acquired in response to an event. The status information of a pallet is related to the status of each of the resources loaded on the pallet. The status information of a pallet can include, but is not limited to, physical conditions, environmental conditions, and physical attributes of the resources loaded on the pallet. The status information of a pallet can be acquired by communicating with the pallet, and/or with other pallets of the plurality of pallet devices and/or with at least one system server, depending on a type of embodiment or circumstances. In order to determine the status information of a pallet, the pallet device 106 associated with the pallet can communicate with the resource 108 to acquire the status information of the resource 108. Acquiring the status information may also require communication with one or more of the plurality of sensors coupled to one or more of the plurality of pallets. The one or more sensors 110 can sense the physical conditions of the pallet 104. Examples of physical condition include, but are not limited to, weight, volume and temperature. In accordance with some embodiments, the pallet device may acquire the status information of the resource by obtaining a resource identifier from the resource by wirelessly communicating with a resource identifier device. An example of a resource identifier device is an RFID tag. An RFID tag can contain resource identifiers with information about the one or more resources. A resource identifier may comprise, but is not limited to, one or more of a product name, a product ID, a manufacturing date, an expiration date, a weight, or a set of physical dimensions. A resource identifier may be wirelessly communicated to at least one system server to obtain physical or other attributes associated with one or more resources. For example, the pallet device 106 communicates a resource identifier containing information such as a product name and a weight to the server to obtain information about the physical dimensions corresponding to the resource 202. In accordance with some embodiments, the pallet device 106 communicates a resource identifier to at least one system server in order to obtain inventory lists associated with one or more pallets and the resource identifier.

In accordance with some embodiments, a pallet device communicates with at least one other pallet device to determine the location of a resource, which is then reported by the pallet device to either a decentralized control system device or an operator device. A decentralized control system device may be a combination of a central controller and a database server. An operator device may be a human interaction device in the decentralized control system 100. An operator device may be a fixed or mobile terminal from which the user can get instructions about the movement of resources. In accordance with some embodiments in the present invention, an operator device is a display device that communicates the location of the resource to an operator.

At step 306, reporting conditions are determined based on the status information of the resources loaded on a pallet. Examples of positive reporting conditions include, but are not limited to, a resource-missing status, a resource-lost status, a utilization status, an environmental status, and an unloading status. In accordance with some embodiments, a resource-missing status is reported when a resource is not found on a pallet. For example, if the resource 202, loaded on the pallet 104, is determined to be missing by the pallet device 106, a resource-missing status is reported. A resource-lost status is reported when a resource is determined to be absent from a certain set of the plurality of pallets. In other words, a resource-lost status is reported when the resource has moved out of an inventory domain without updating at least one of the system servers. Examples of inventory domains include, but are not limited to, a shipping domain, a work in progress domain, and a dispatch domain. The pallet device 106 queries the pallet 104 and communicates with neighboring pallet devices to find the resource 204. In accordance with some embodiments, the resource-lost status is reported when the resource 204 is determined to be missing from the pallet 104 and from the neighboring pallets in an inventory domain. A utilization status is the utilization of a pallet for a specific period of time and includes information about the period during which the pallet is loaded with one or more resources. For example, if the utilization status of the pallet 104 is ten hours, it implies that the pallet is loaded for ten hours with one or more resources.

An underutilized status is an interval of time when resources are not loaded on a pallet, or are loaded but not to the pallet's full capacity. For example, if the underutilized status of pallet 104 is five hours, it implies that the pallet 104 is not loaded with the one or more resources for five hours. The pallet's full capacity is predefined based on pallet parameters. Examples of pallet parameter include, however are not limited to, maximum weight on the pallet, maximum volume of products on the pallet, and temperature of the pallet. An environmental status is reported when a change occurs in the desired environmental conditions of a resource. The environment parameters can be temperature, pressure, and so forth. For example, in cold storage, if the desired temperature of a resource is minus five degrees, the pallet device 106 will report an alert if there is a significant change in the temperature from minus five degrees (such as exceeding 0 degrees Celsius).

In accordance with some embodiments, the system server 102 is informed when there is a significant change in the weight, volume, and so forth, of the one or more resources

Based on the reporting conditions defined above, the pallet device 106 may broadcast the status information to neighboring pallet devices in order to enquire about a changed resource. If a resource is missing from the pallet device, resource identifiers that contain information about the missing resource are communicated from the neighboring pallet devices to the pallet device 106. Based on the resource identifiers, the pallet device 106 may report the resource-missing status to the system server 102 when the missing resource is not determined to be present on the pallet or neighboring pallets (i.e., under a positive reporting condition). At step 308, the status information can be reported to at least one of the system servers and/or reported to at least one of the plurality of pallet devices, based on the reporting condition being positive At step 310, the method for resource management is terminated.

In accordance with some embodiments, an event is a message that conveys a pallet configuration that defines a set of resources to be loaded on a pallet. A pallet configuration can be used to determine whether a pallet is loaded correctly or incorrectly. A pallet configuration can be based on availability and location of the set of resources. At least one other pallet device may be queried to determine a location of at least one resource of the plurality of resources and a location of at least one resource of the plurality of resources is reported to either a decentralized control system device or an operator device. Thereafter, status information of a resource is acquired in response to an event based on the monitoring of the plurality of resources by the plurality of pallet devices. Monitoring further includes generating an inquiry to a decentralized control system device by a pallet device. Further, a positive reporting condition of a correctly loaded pallet unloaded in an inventory shipping domain may be determined by a pallet device. An unloading status causing a positive reporting condition is reported to a system server when an incorrectly loaded pallet is unloaded in an inventory shipping domain.

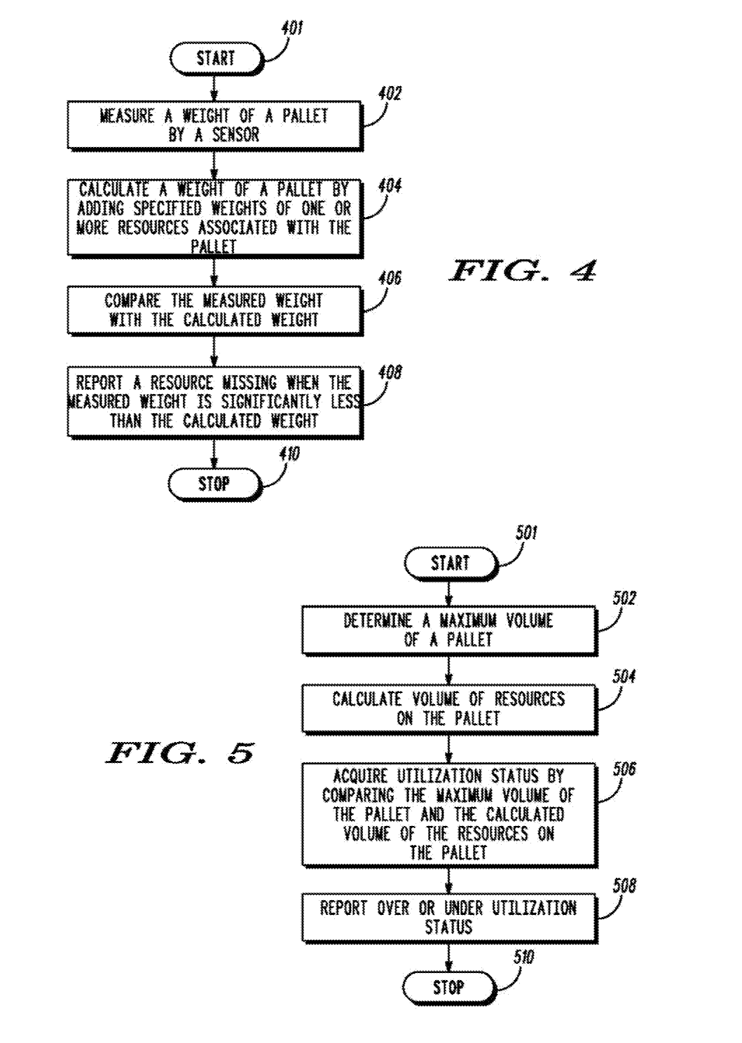

Referring to FIG. 4, a flow diagram illustrates a method for reporting a resource-missing status, in accordance with some embodiments. At step 401, the method for determining a resource-missing status information is initiated. This may a periodic event that is initiated by a pallet device. At step 402, the pallet device 106 interacts with the sensor 10 to measure the weight of the one or more resources on the pallet 104. At step 404, the specified weight of the pallet is calculated by adding the specified weights of the one or more resources associated with the pallet 104. The specified weights of the one or more resources are determined by wirelessly communicating with at least one system server. The specified weight of the one or more resources can be the weight of the one or more resources registered in the database servers. In accordance with some embodiments, the specified weights of resources 202, 204, 206 and 208 are identified by the pallet device 106 by querying at least one system server. The specified weight of the pallet is calculated by adding the specified weights of the one or more resources. The weights may then be compared. At step 406, status-missing information is acquired when a determination is made that there is a significant negative difference between the measured weight of the pallet and the calculated weight of the pallet For example, if the measured weight is at least a marginal amount less than the calculated weight, a resource-missing status has been acquired. At step 408, a positive reporting condition is determined because a resource-missing status has been acquired, so the pallet reports the status information to a system server, for example (or, for example, the report may go to an intermediate pallet device that may relay the information to a system server). The marginal amount may be conveyed to the pallet device with other resource information, such as the weight of a resource, or may be an amount based on, for example, an accuracy or precision of a weight sensor. The method ends at step 410.

Referring to FIG. 5, a flow diagram illustrates a method for a utilization status of a pallet, in accordance with some embodiments. The utilization status includes the utilization level of a pallet. In some embodiments, the utilization status is based on the volumetric capacity of the pallet 104. At step 501, the method for determining a utilization status of the pallet 104 is initiated. This may a periodic event that is initiated by a pallet device. At step 502, the maximum volume of the pallet 104 is determined by querying at least one system server. At step 504, the volume of resources on the pallet is calculated. In accordance with some embodiments, the pallet device 106 interacts with the RFIDs associated with each of the resources to determine their actual volume. The volume of each of the resources on the pallet is added to calculate a total volume of the resources. At step 506, utilization status information is determined. The utilization status is acquired based on the maximum volume of the pallet and the total volume of the resources. In accordance with some embodiments, when the maximum volume of the pallet is more than the total volume of the resources, an underutilized status is determined and is a positive reporting condition, so the underutilized status is reported. However, when the maximum volume of the pallet is less then the total volume of the resources, an over-utilized status is determined and is a positive reporting condition, so the underutilized status is reported. In accordance with some embodiments, the over-utilization status and the underutilization status are reported at step 508 to at least one system server. At step 510, the method for reporting a utilization status of the pallet 104 is terminated.

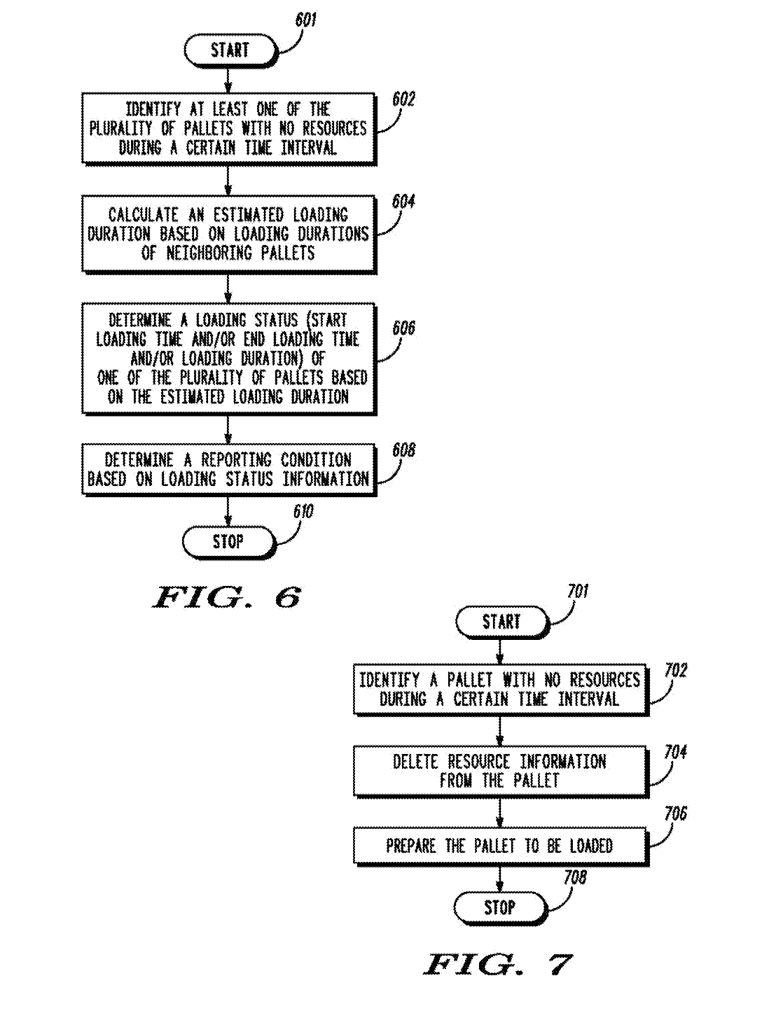

Referring to FIG. 6, a flow diagram illustrates a method for determining a loading status of a pallet, in accordance with some embodiments. As described earlier, the pallet loading status can be determined based on the utilization of the pallet for a certain period. At step 601, the method for determining a loading status of a pallet 104 is initiated. This may a periodic event that is initiated by a pallet device. At step 602, at least one of the plurality of pallets, with no resource loaded for a certain period, is identified. At step 604, a loading duration of the neighboring pallets is calculated based on the time that elapses for loading each of the neighboring pallets that have been loaded within some time period. The neighboring pallets are in the same inventory domain as pallet 104. The loading durations are used to anticipate when loading will begin and be completed for the pallet with no resources. In accordance with some embodiments, the loading duration of the neighboring pallets is communicated to the pallet device 106 associated with the pallet 104 that has no resources loaded. The loading status for a pallet with no resources loaded may include one or more of the times when the loading is estimated to begin, when the loading is estimated to end, and the duration for loading. The utilization status may be calculated based on the loading durations of the neighboring pallets. At step 606, the loading status of at least one of the plurality of pallets that has no resources is determined based on the loading durations. The pallet device may report to at least one system server based on a positive reporting condition determined at step 608 from the loading status. In some embodiments, a positive reporting condition may arise when a pallet device has determined that the pallet is empty during a normal monitoring event and the pallet device has then estimated a loading duration and a time by which the pallet should be fully loaded. In accordance with some embodiments, a positive reporting condition arises when there is a deviation in the loading of the pallet 104 from its loading status. As a result of one of these positive reporting conditions, the system server 102 is notified. At step 610, the method for determining a loading status is terminated.

Referring to FIG. 7, a flow diagram illustrates a method for resetting a pallet device, in accordance with some embodiments. A reset state of the pallet device 106 is reported to the system server 102 based on the resetting of the pallet device 106 when there is a change in a loading status of the pallet 104. The loading status can range from an unloaded state to a completely loaded state or vice-versa. The unloaded state refers to the condition when there is no resource loaded on the pallet 104. The completely loaded state of the pallet 104 can be based on predefined maximum number of resources that can be loaded on the pallet 104. In accordance with some embodiments, the reset state is reported to the system server 102 when the pallet 104 is not reset, in response to a change in loading status from a loaded to an unloaded state or vice versa. At step 701, the method for resetting the pallet device 106 is initiated. At step 702, the pallet device 106 determines whether the pallet 104 has been in an unloaded state for a certain period of time. This may a periodic event that is initiated by the pallet device. When it has been in the unloaded state for a certain period of time, the resource information in the pallet device 106 is deleted at step 704. For example, the pallet device 106 deletes the resource information of the one or more resources when the one or more resources have not been present on the pallet 104 for a certain time, say 10 minutes. At step 706, the pallet device 106 is prepared to receive information on the new resources to be loaded on the pallet 104. In accordance with some embodiments, the pallet device 106 can be automatically reset after regular intervals. At step 708, the method for resetting the pallet device 106 is terminated.

Various embodiments, as described above, provide a method for resource management in a supply chain. This is achieved by a decentralized control system 100 managing resources in the supply chain in an intelligent manner with knowledge and information shared across resources and pallets in the supply chain. The disclosed method reduces the number of alerts raised to the system server and substantially decreases the amount of data handled by the system server.

It will be appreciated that the method of resource management as described herein may be comprised of one or more conventional processors and unique stored program instructions that control the one or more processors to implement some, most, or all of the functions described herein; as such, the functions of resource management used by a pallet device that can be associated with the pallet in a supply chain may be interpreted as being steps of a method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” “includes,” “including” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another,” as used herein, is defined as at least a second or more. The terms “including” and/or “having,” as used herein, are defined as comprising. The term “program,” as used herein, is defined as a sequence of instructions designed for execution on a computer system. A “program,” or “computer program,” may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for resource management used by a pallet device that can be associated with a pallet in a supply chain, the pallet being associated with one or more resources, the supply chain having a decentralized control system that has at least one system server, a plurality of pallets, a plurality of pallet devices and a plurality of resources, the method comprising:
detecting an event;
acquiring a status information of at least one of the plurality of pallets in response to the event;
determining reporting condition for at least one of the one or more resources based on the status information; and
reporting the status information to one of the at least one system server and the plurality of pallet devices, based on the reporting condition being positive.

2. The method according to claim 1, wherein the event being one or more from a group consisting of a change of a sensed value, a time-related condition, and a receipt of a wireless message.

3. The method according to claim 1, wherein the event being a message that conveys a pallet configuration that defines a set of resources with which the pallet is to be loaded, and wherein the acquiring of status information comprises monitoring the one or more resources loaded onto the pallet, and wherein a determination is made that a positive reporting condition exists based upon a determination that a pallet has been unloaded in a shipping domain, and wherein the reporting the status information comprises reporting an unloading status.

4. The method according to claim 3, further comprising acquiring information associated with the set of resources by generating an inquiry to a decentralized control system device and wherein a determination of one of the correctly loaded pallet and an incorrectly loaded pallet is made based upon the pallet configuration, the information associated with the set of resources, and identification information acquired by wireless communication with at least one resource radio frequency identification (RFID) tag loaded on the pallet.

5. The method according to claim 4, further comprising:
communicating with at least one other pallet device to determine a location of at least one resource of the set of resources; and
reporting the location of the at least one resource of the plurality of resources to one of the decentralized control system device and an operator device.

6. The method according to claim 1, wherein the acquired status information is relevant to the status of the plurality of resources associated with the plurality of pallets.

7. The method according to claim 1, wherein acquiring the status information comprises communicating with at least one of the plurality of pallet devices and the at least one system server.

8. The method according to claim 1, wherein acquiring the status information comprises wirelessly communicating with one or more resources, each of the one or more resources having an RFID tag associated with it.

9. The method according to claim 1, wherein acquiring the status information comprises communicating with one or more sensors coupled to at least one of the plurality of pallet devices, the one or more sensors sensing one or more physical conditions.

10. The method according to claim 1, wherein acquiring the status information comprises at least one of:
obtaining a resource identifier by wirelessly communicating with resource identifier devices, the resource identifier devices being associated with one or more of the plurality of resources loaded on the pallet;
wirelessly communicating the resource identifiers to the at least one system server to obtain physical attributes associated with the resource identifiers; and
wirelessly communicating the resource identifiers to the at least one system server to obtain one or more pallet inventory lists.

11. The method according to claim 1, wherein determining a positive reporting condition comprises acquiring a resource-missing status, the resource-missing status being based on a resource missing from the one or more resources.

12. The method according to claim 11, wherein acquiring a resource-missing status comprises determining a resource-lost status, the resource-lost status being based on a resource missing from a group of pallets, the group of pallets being associated with at least one of the plurality of pallet devices.

13. The method according to claim 11, wherein acquiring the resource-missing status comprises:
measuring a weight of the pallet by a sensor;
calculating a weight of the pallet by summing specified weights of the one or more resources being associated with the pallet; and
determining a resource-missing status based on a comparison of the measured weight with the calculated weight.

14. The method according to claim 13, wherein calculating the weight of the pallet comprises determining the specified weights of the one or more resources by wirelessly communicating with the at least one system server.

15. The method according to claim 1, wherein reporting the status information comprises reporting a missing pallet, the pallet having been determined to be absent from the supply chain by communications involving at least one of the plurality of pallet devices.

16. The method according to claim 1, wherein reporting the status information comprises reporting a utilization status of a pallet, the utilization status being based on volumetric capacity of the pallet.

17. The method according to claim 16, wherein acquiring the utilization status comprises:
determining a maximum volume of the pallet;
calculating a total volume of resources on the pallet; and
determining a utilizing status based on the maximum volume of the pallet and the total volume of the resources on the pallet.

18. The method according to claim 1, wherein reporting the status information comprises reporting a pallet utilization status of the pallet, the pallet utilization status being determined based on utilization of the pallet for a certain time interval.

19. The method according to claim 18, wherein determining the pallet utilization status of the pallet comprises:
identifying at least one of the plurality of pallets with no resource for a certain time interval;
calculating at least one loading duration of at least one neighboring pallet; and
determining a loading status of the at least one of the plurality of pallets based on the at least one loading duration.

20. The method according to claim 1, wherein reporting the status information comprises reporting a pallet specification, the pallet specification being determined based on environmental parameters.

21. The method according to claim 1, wherein reporting the status information comprises reporting a reset state of the pallet device when the pallet is not reset in response to a change in a loading state of the pallet, the loading state being one of an unloaded state and a utilized state.

22. The method according to claim 21, wherein resetting the pallet device comprises:
determining a pallet with no resources for a certain time interval;
deleting a resource information in the pallet device corresponding to the pallet; and
setting the pallet device in a ready state to update the resource information corresponding to the pallet.
